(19) United States
(12) Patent Application Publication
(10) Pub. No.: US 2023/0218020 A1
(43) Pub. Date: Jul. 13, 2023

(54) INFECTION PREVENTION BAG USED WHEN COLLECTING SPECIMEN FROM NASOPHARYNX

(71) Applicant: Yoshimasa TAGUCHI, Tokyo (JP)

(72) Inventor: Yoshimasa TAGUCHI, Tokyo (JP)

(21) Appl. No.: 17/995,572

(22) PCT Filed: Apr. 2, 2021
(86) PCT No.: PCT/JP2021/014295

§ 371 Date: Oct. 5, 2022

(30) Foreign Application Priority Data
Apr. 6, 2020 (JP) 2020-068314

(51) Int. Cl. A41D 13/11; A62B 18/10

(52) U.S. Cl. CPC A41D 13/1153; A41D 13/1161; A62B 18/10

(57) ABSTRACT

When collecting a sample of influenza, coronavirus, and the like, the present invention protects a tester from a droplet infection due to a patient’s cough and/or sneeze caused by inserting a swab into nasopharynx to collect the sample from the nasopharynx. At the time of a virus test such as influenza, a patient’s nose and mouth are covered with a bag having a hole through which the testing swab can be passed, and the swab is inserted through the hole from the surface of the bag into the nasopharynx for collecting the sample, and therefore, the droplets scattered by cough and/or sneeze during the test are prevented from being scattered out of the bag, thereby an infection to a practitioner carrying out the test can be prevented.

### TECHNICAL FIELD

The present invention relates to an infection prevention bag to be worn to a patient when collecting sample from nasopharynx.

### BACKGROUND ART

In an infection test of influenza, coronavirus, and the like, a method of inserting a swab for sampling into nasopharynx is used for collecting sample.

However, since the swab is inserted into the nasopharynx, there is a problem that a practitioner collecting sample becomes infected by droplet infection due to a patient’s cough and/or sneeze.

As an improvement measure for this problem, a mask for examination and diagnosis has been proposed. A transparent part is formed in a main body of the mask at a position corresponding to a wearer’s nose and mouth or near of them and a ventilation fill is formed in other parts, and a transparent part hole is opened to allow a rod body to pass therethrough.

### Prior Art Document

### Patent Document

Patent document 1: JP 2011-120647A

### SUMMARY OF THE INVENTION

### Problem to Be Solved by the Invention

The problems to be solved are that it is difficult to mass-produce the mask since the above mask has a complicated structure, and therefore, when a large number of patients should be tested in a pandemic or the like, the necessary number of the mask cannot be provided to a medical institution, that when sneezing during a test, droplet is not scattered in a front direction of the mask, but droplet is scattered from a gap between the mask and a face to contaminate a room, and that a very small virus such as coronavirus passes through a filter provided in the front direction of the mask.

### Means of Solving the Problems

The present invention is characterized most primarily by a bag having a hole through which a testing swab can be passed, which is to be worn to a patient when collecting a sample.

### Effect of the Invention

The infection prevention bag used when collecting sample according to the present invention has an advantage of an effect of preventing the cough and/or sneeze from being scattered and therefore, suppressing a secondary infection to practitioners by having a patient wear a bag having a hole through which a testing swab can be passed and made of a material that does not allow a virus to pass therethrough. There is also an advantage that the infection prevention bag has a simple structure and therefore can be mass-produced easily and cheaply.

### BRIEF DESCRITION OF THE DRAWINGS

FIG. 1 is a view showing a method for carrying out an infection prevention bag used when collecting sample according to the present invention.

FIG. 2 is a front view of a main body.

FIG. 3 is a bottom view of the main body.

FIG. 4 is a side view.

FIG. 5 is a front view of the main body using a check valve.

FIG. 6 is a view of a hole opened in the main body and a droplet splash prevention valve.

FIG. 7 is a front view of the main body provided with a simple droplet splash prevention valve.

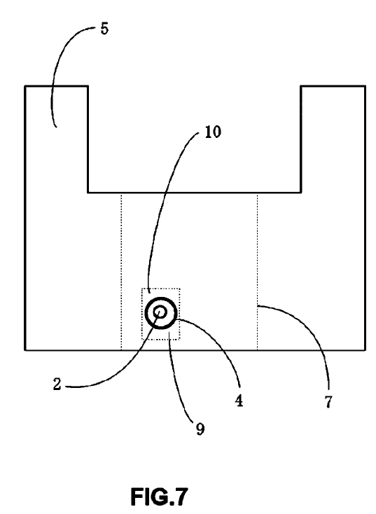

### MODE FOR CARRYING OUT THE INVENTION

Hereinafter, the best mode for carrying out the present invention will be described.

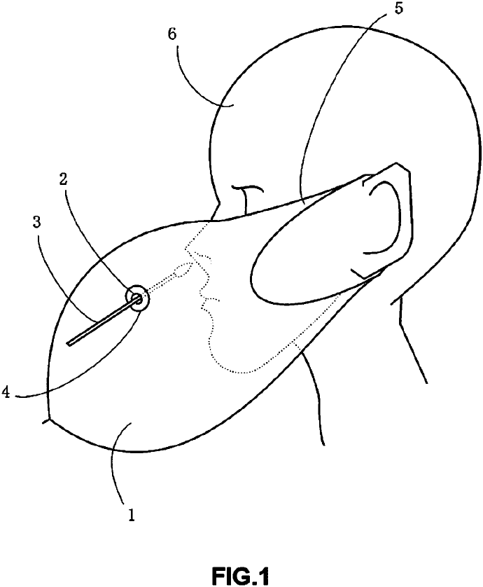

FIG. 1 shows a method of carrying out an infection prevention bag used when collecting sample according to the present invention. A bag main body 1 is characterized by having a shape of a bag. The reason is to prevent infected droplets discharged by cough and/or sneeze from being scattered out of the bag when a testing swab is inserted into the nasopharynx. The maximum capacity of a sneeze cannot exceed a lung capacity. At the same time, it is generally known that the lung capacity of adult men and women is from more than or equal to 3000 cc to less than or equal to 4500 cc. Considering these two points as well as the cost of materials and the time and effort for transportation and disposal, it is preferable that the capacity of the bag main body is from more than or equal to 3000 cc to less than or equal to 5000 cc. Also, it is preferable that the capacity of the bag main body for children is from more than or equal to 1600 cc to less than or equal to 2000 cc since the lung capacity of elementary school boys and girls is from more than or equal to 1600 cc to less than or equal to 1850 cc.

With regard to the material of the bag main body, a material which does not allow a virus to pass therethrough from the inside to the outside of the bag main body 1, that is a material made of a synthetic resin such as vinyl or polyethylene is most suitable. Further, a permeable material capable of observing the nasopharynx is most suitable in order to improve the efficiency of an operation for collecting sample.

A size of a hole 2 through which a testing swab 3 is passed depends on the size of the testing swab 3. The hole 2 should be as small as possible in accordance with the size of the testing swab 3. This is because there is a high probability that the virus is scattered from the hole 2 when a patient 6 sneezes.

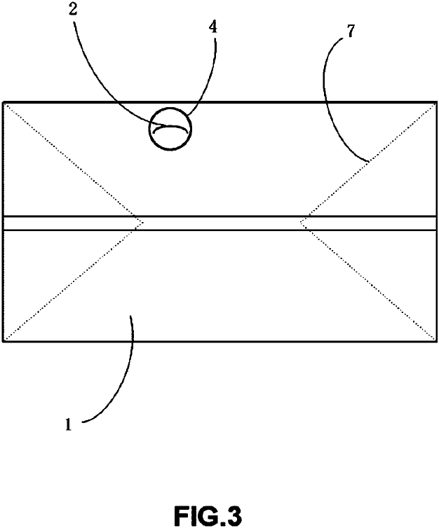

Since there is a possibility that the droplets may be scattered due to the internal air pressure even if a circular hole is small, for example, a cut through which the testing swab 3 is passed can be made in the bag instead of the circular hole. The shape of the cut is not limited to a straight line as shown in the hole 2 of FIG. 3. As long as the testing swab 3 can be passed therethrough, the shape of the hole 2 should not be linear, but may be, for example, a Y-shaped or a cross-shaped cut.

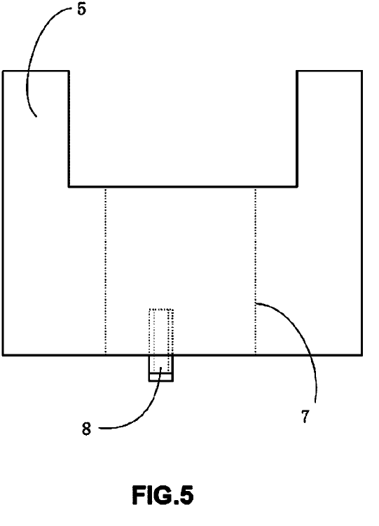

In order to prevent the droplets from being scattered from the hole 2, the possibility of scattering of droplets can be more reduced by using a check valve 8 in the hole 2 as shown in FIG. 5 even when sneezing after the testing swab 3 is taken out.

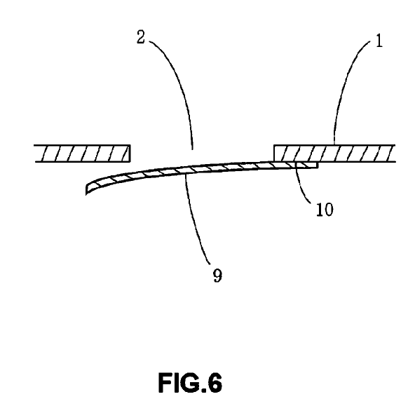

The below shows an easier method than the method of using the check valve 8. In FIG. 6, the upper part shows an outside of the bag main body, the lower part shows an inside of the bag main body, and the right side shows a bag mouth side to be put on a mouth of a face of a patient. In order to stick and fix a simple droplet splash prevention valve 9 closing the hole 2 only to the inside of the bag main body 1 at the bag mouth side thereof, the simple droplet splash prevention valve 9 is stuck to a sticking part 10 on the bag mouth side so that the bag bottom side of the simple droplet splash prevention valve 9 is set free without fixing. As a result, the simple droplet splash prevention valve 9 can prevent the air generated inside of the bag main body 1 from flowing out of the hole 2 by a sneeze, and reduce the scattering of the virus from the hole 2, not only when the testing swab 3 is not inserted but also when the testing swab 3 is inserted.

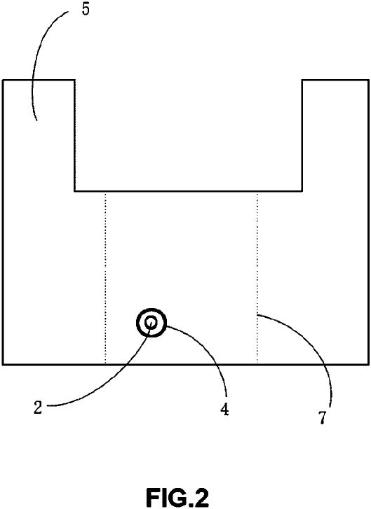

With regard to the position of the hole 2, when explaining based on the front view of the bag main body of FIG. 2, it is preferable that the distance from the position of the hole 2 to the bag mouth part to be put on the face in a direction toward the bag bottom part is 4 cm or more. In this connection, the operation for collecting the sample cannot be properly carried out when the position of each naris of the nasopharynx from which the sample is to be collected and the position of the hole 2 of the bag main body 1 cannot overlap to each other. Thus, the distance from the hole 2 to the bag mouth part is important. Further, when a synthetic resin material such as vinyl or polyethylene is used for the bag main body, the bag main body is flexible. Therefore, even if the distance from the hole 2 to the bag mouth part to be put on the face is 4 cm or more and the hole is formed near the bag bottom part, the operation for collecting sample will not be disturbed since the capacity of the bag is in a degree of 5000 cc.

As described above, it is difficult to find the hole 2 since the hole is very small, and therefore, it is preferable to put a mark 4 showing a position of the hole. Although the mark 4 can be a printing, a sticker or the like to close the hole 2 that can be easily peeled off may be stuck to the hole 2 to show the position of the hole.

When the hole 2 is opened in the bag main body 1, the bag main body 1 may be punched through the bag main body by a hole punch or the like in order to simplify a manufacturing process. At this time, a plurality of holes may open, and in that case, it is preferable to stick a peelable sticker to each of the holes 2.

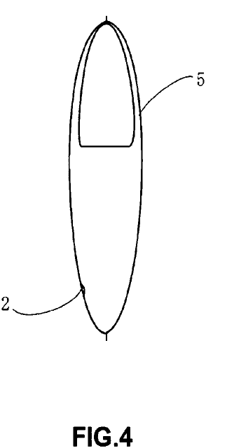

Although the bag main body 1 of FIGS. 1, 2, 4, and 5 shows a structure with an ear hook for wearing it on the face, the structure for wearing it on the face 5 is not necessarily required if the patient 6 can hold the bag main body 1 with both hands when collecting sample. However, such a structure is necessary for testing a hand handicapped person or preventing the virus from being scattered by releasing the hands when sneezing. The structure for wearing the bag on the face can be selected freely so long as the bag can be worn to the face.

DESCRIPTION OF REFERENCE SINGS

| | |
|---|---|
| 1··· | Bag main body |
| 2··· | Hole |
| 3··· | Testing swab |
| 4··· | Mark showing a position of the hole |
| 5··· | Structure for wearing the mask on the face |
| 6··· | Patient |
| 7··· | Gusset |
| 8··· | Check valve |
| 9··· | Simple droplet splash prevention valve |
| 10··· | Sticking part |

1. An infection prevention bag used when collecting a sample from nasopharynx, comprising: a bag main body made of a material that does not allow a virus to pass therethrough from the inside to the outside thereof and having a capacity in a degree of a lung capacity of a person to be tested; and a testing swab insertion hole which is formed in the bag main body and has a minimum size from which the testing swab can be inserted, wherein the testing swab insertion hole is provided in the bag main body at a position of 4 cm or more away from a bag mouth part toward a bag bottom part.

2. An infection prevention bag used when collecting a sample from nasopharynx, comprising: a bag main body made of a material that does not allow a virus to pass therethrough from the inside to the outside thereof and having a capacity in a degree of a lung capacity of a person to be tested; and a testing swab insertion hole which is formed in the bag main body and has a minimum size from which the testing swab can be inserted, wherein a mark showing a position of the testing swab insertion hole is provided on the bag main body.

3. An infection prevention bag used when collecting a sample from nasopharynx, comprising: a bag main body made of a material that does not allow a virus to pass therethrough from the inside to the outside thereof and having a capacity in a degree of a lung capacity of a person to be tested; and a testing swab insertion hole which is formed in the bag main body and has a minimum size from which the testing swab can be inserted, wherein a peelable seal as a mark showing a position of the testing swab insertion hole is provided on the bag main body.

4. The infection prevention bag used when collecting a sample from nasopharynx as claimed in claim 1, wherein the bag main body is made of a synthetic resin material such as vinyl, polyethylene, or the like.

5. The infection prevention bag used when collecting a sample from nasopharynx as claimed in claim 1, wherein the bag main body is made of a permeable material.

6. The infection prevention bag used when collecting a sample from nasopharynx as claimed in claim 1, wherein the capacity of the bag main body is more than or equal to 1600 cc.

7. The infection prevention bag used when collecting a sample from nasopharynx as claimed in claim 1, wherein the testing swab insertion hole of the bag main body is provided with a check valve mechanism.

8. The infection prevention bag used when collecting a sample from nasopharynx as claimed in claim 1, wherein a simple droplet splash prevention valve (9) is provided at a position inside the bag main body and corresponding to the testing swab insertion hole.

9. The infection prevention bag used when collecting a sample from nasopharynx as claimed in claim 1, wherein a mark showing a position of the testing swab insertion hole is provided on the bag main body.

10. The infection prevention bag used when collecting a sample from nasopharynx as claimed in claim 1, wherein a peelable seal as a mark showing a position of the testing swab insertion hole is provided on the bag main body.

11. The infection prevention bag used when collecting a sample from nasopharynx as claimed in claim 1, wherein the bag main body is further provided with a structure to be fixed to a face of the person.

12. A method for collecting a sample from nasopharynx using the infection prevention bag used when collecting a sample from nasopharynx as claimed in claim 1, wherein the method is used when collecting the sample from nasopharynx.

13. The infection prevention bag used when collecting a sample from nasopharynx as claimed in claim 2, wherein the bag main body is made of a synthetic resin material such as vinyl, polyethylene, or the like.

14. The infection prevention bag used when collecting a sample from nasopharynx as claimed in claim 3, wherein the bag main body is made of a synthetic resin material such as vinyl, polyethylene, or the like.

15. The infection prevention bag used when collecting a sample from nasopharynx as claimed in claim 2, wherein the bag main body is made of a permeable material.

16. The infection prevention bag used when collecting a sample from nasopharynx as claimed in claim 3, wherein the bag main body is made of a permeable material.

17. The infection prevention bag used when collecting a sample from nasopharynx as claimed in claim 2, wherein the bag main body is further provided with a structure to be fixed to a face of the person.

18. The infection prevention bag used when collecting a sample from nasopharynx as claimed in claim 3, wherein the bag main body is further provided with a structure to be fixed to a face of the person.

19. A method for collecting a sample from nasopharynx using the infection prevention bag used when collecting a sample from nasopharynx as claimed in claim 2, wherein the method is used when collecting the sample from nasopharynx.

20. A method for collecting a sample from nasopharynx using the infection prevention bag used when collecting a sample from nasopharynx as claimed in claim 3, wherein the method is used when collecting the sample from nasopharynx.
